(19) United States
(12) Patent Application Publication
(10) Pub. No.: US 2026/0328507 A1
(43) Pub. Date: Oct. 22, 2026

(54) Firearm Corrosion Reduction Device

(71) Applicant: Shan Hemphill, Potlatch, ID (US)

(72) Inventor: Shan Hemphill, Potlatch, ID (US)

(21) Appl. No.: 19/652,145

(22) Filed: Apr. 20, 2026

Related U.S. Application Data
(60) Provisional application No. 63/792,029, filed on Apr. 21, 2025.

(51) Int. Cl. F41A 9/65; B01D 53/26; B01D 53/28; C23F 11/02

(52) U.S. Cl. CPC F41A 9/65; B01D 53/263; B01D 53/28; C23F 11/02; B01D 2252/10; B01D 2252/606; B01D 2257/80

(57) ABSTRACT

A corrosion reduction device for a firearm includes a magazine body for insertion into a magazine well of the firearm, the magazine body having a top end, a bottom end, and a main interior cavity within the magazine body configured to receive a desiccant material. An access structure is provided on the magazine body for accessing the main interior cavity to allow access to the desiccant material and a plurality of vents in the magazine body are configured to permit moisture transfer between desiccant in the interior cavity and the firearm interior.

### RELATED APPLICATION

This application claims priority to U.S. Provisional Application Ser. No. 63/792,029, titled “Firearm Corrosion Reduction Device,” filed Apr. 21, 4025, which is incorporated herein by reference in its entirety.

### TECHNICAL FIELD

The present disclosure relates generally to apparatus and methods of preventing firearms corrosion, and firearms storage. More particularly, the present invention is directed to a firearm cartridge which provides desiccant properties to components of a firearm which are vulnerable to corrosion and/or a buildup of moisture.

### BACKGROUND

Firearms are commonly stored in enclosed spaces such as trunks, closets, and gun safes. Environmental conditions such as humidity and temperature changes may cause corrosion to damage exposed metals of firearms, which often goes unnoticed until significant damage has occurred. Humidity reduction with desiccant, airflow, heat, and volatile corrosion inhibitors are all used to reduce or prohibit corrosion or a buildup of moisture. However, each of these has a current drawback in current methods of use:

Desiccant is often placed on a shelf or floor of a storage closet or the like, placing it near the stored firearms.

Airflow and heat often require power sources, which may not be available in the storage closets.

Volatile corrosion inhibitors are sometimes used within manufacturer packaging of firearms, but is not effective when the firearm is removed from packaging.

If a firearm is transferred from one storage location to another, the drying agent or corrosion inhibitor is typically not transported with the firearm.

### SUMMARY OF THE DISCLOSURE

In an embodiment, a corrosion-reduction device for a firearm includes a magazine body that has an interior cavity for receiving a desiccating drying agent, and optionally a volatile corrosion inhibitor, that will be in close proximity to critical firearm components when the magazine body is inserted into a magazine well of the firearm. In particular, a non-functioning “dummy” magazine is disclosed for coupling to a corresponding firearm in its usual manner, and wherein, the magazine is designed to house a substance which prevents or limits corrosion or a buildup of humidity in components of the firearm vulnerable to such conditions.

In an embodiment, a corrosion reduction device for a firearm, includes a magazine body for insertion into a magazine well of the firearm, the magazine body having a main interior cavity configured to receive a desiccant material, an access structure on the magazine body to load the desiccant material into the main interior cavity, and at least one vent in the magazine body between the main interior cavity and the firearm interior to provide communication of desiccant material from the main interior cavity to the firearm interior.

In yet another embodiment, a method is disclosed for inhibiting corrosion in a firearm by loading a desiccant into a non-functional magazine-shaped device, inserting the device into a magazine well of the firearm such that vents on the device face a chamber region, storing the firearm, and removing and recharging the desiccant when an indicator reaches a predetermined state.

### BRIEF DESCRIPTION OF THE FIGURES

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a perspective view of a firearm corrosion reduction device for a handgun, in embodiments.

FIG. 1B is a side view of the device of FIG. 1A, in embodiments.

FIG. 1C is a sectional view of the device of FIG. 1B, in embodiments.

FIG. 1D is a sectional view of the device of FIG. 1C, in embodiments.

FIG. 1E is a plan view of a baseplate for use with the device of FIG. 1A, in embodiments.

FIG. 1F is a side view of the baseplate of FIG. 1E, in embodiments.

FIG. 2A is a perspective view of a firearm corrosion reduction device for a rifle, in embodiments.

FIG. 2B is a side view of the device of FIG. 2A, in embodiments.

FIG. 2C is a sectional view of the device of FIG. 2B, in embodiments.

FIG. 2D is a sectional view of the device of FIG. 2C, in embodiments.

FIG. 2E is a plan view of a baseplate for use with the device of FIG. 2A, in embodiments.

FIG. 2F is a side view of the baseplate of FIG. 2E, in embodiments.

FIG. 3A is a side view of a firearm corrosion reduction device for a handgun, in embodiments.

FIG. 3B is a rear view of the device of FIG. 3A, in embodiments.

FIG. 3C is a sectional view of the device of FIG. 3B, in embodiments.

FIG. 3D is a top view of the device of FIG. 3A, in embodiments.

FIG. 3E is a bottom view of the device of FIG. 3A, in embodiments.

FIG. 4A is a perspective view of another firearm corrosion reduction device for a handgun, in embodiments.

FIG. 4B is a side view of the device of FIG. 4A, in embodiments.

FIG. 4C is a rear view of the device of FIG. 4A, in embodiments.

FIG. 4D is a sectional view of the device of FIG. 4C, in embodiments.

FIG. 4E is a side view of a baseplate of the device of FIG. 4A, in embodiments.

FIG. 5A is a top view of a firearm corrosion reduction device for a rifle, in embodiments.

FIG. 5B is a side view of the device of FIG. 5A, in embodiments.

FIG. 5C is a bottom view of the device of FIG. 5A, in embodiments.

FIG. 5D is a rear view of the device of FIG. 5B, in embodiments.

FIG. 5E is a sectional view of the device of FIG. 5D, in embodiments.

FIG. 6A is a perspective view of a closure for use with a firearm corrosion reduction device, in embodiments.

FIG. 6B is a side view of the closure of FIG. 6A, in embodiments.

FIG. 6C is a sectional view of the closure of FIG. 6A, in embodiments.

FIG. 7 is a diagram of a humidity indicator, in embodiments.

FIG. 8 is a diagram of a humidity meter, in embodiments.

### DETAILED DESCRIPTION OF THE EMBODIMENTS

In the following description, certain specific details are set forth to provide a thorough understanding of various disclosed embodiments. However, one skilled in the relevant art will recognize that embodiments may be practiced without one or more of these specific details, or with other methods, components, materials, etc.

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Exemplary embodiments will be described in detail herein, with examples thereof represented in the drawings. When the following descriptions involve the drawings, like numerals in different drawings represent like or similar elements unless otherwise indicated. Implementations described in the following exemplary embodiments do not represent all implementations consistent with the present disclosure. Instead, they are merely examples of apparatuses and methods consistent with some aspects of the present disclosure as detailed in the appended claims.

Spatial descriptors like “top,” “bottom,” “front,” and “rear” are used describe relationships between elements of the embodiments discussed herein and have no bearing on the position of the described devices during use.

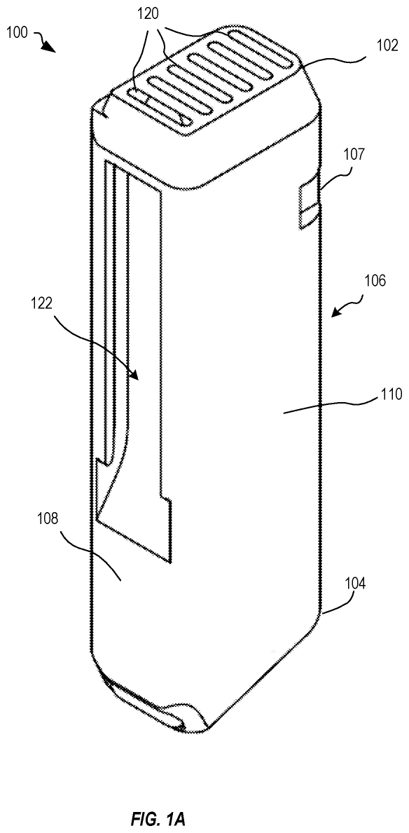

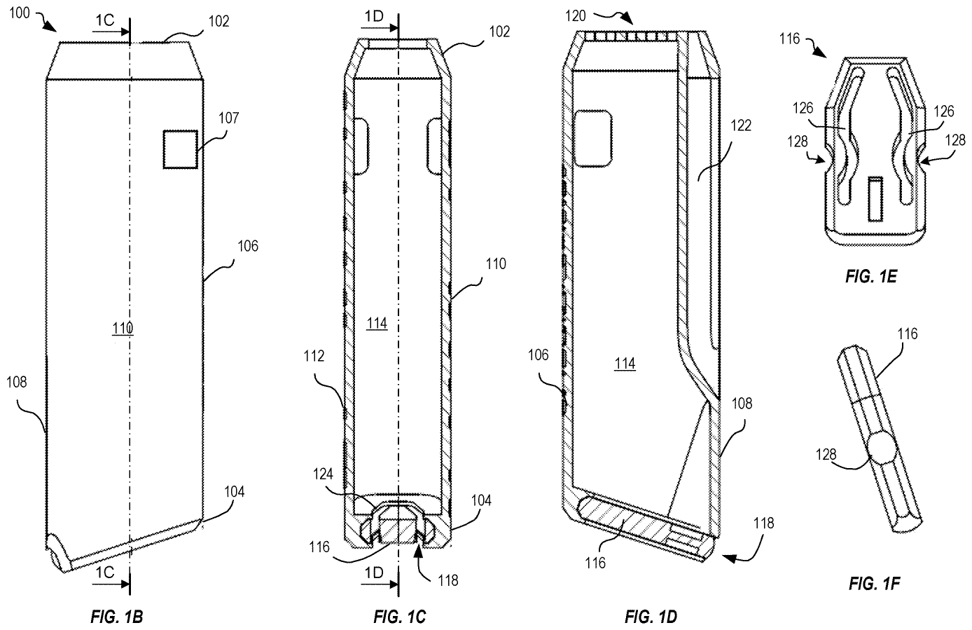

FIGS. 1A-1F show a firearm corrosion reduction device for a handgun and are best viewed together in the following description. FIG. 1A is a perspective view, FIG. 1B is side view, FIG. 1C is a rear view, and FIG. 1D is a sectional view. FIG. 1E is a plan view of a baseplate for use with the device and FIG. 1F is a side view of the baseplate.

FIG. 1A is a perspective view of the device, which includes magazine body 100 for insertion into a magazine well of a firearm such as a handgun. It is sized and shaped to correspond to a factory magazine of the firearm. Magazine body 100 includes top end 102 which is inserted into the magazine well, bottom end 104, front wall 106, rear wall 108, right side wall 110, and left side wall 112. Magazine body 100 includes a main interior cavity 114 for receiving a desiccant material. In embodiments, magazine body 100 includes a catch 107 for engaging with the magazine well of the firearm.

A substance such as a Volatile Corrosion Inhibitor (VCI) may also be used with magazine body 100. VCI is a chemical substance that acts to reduce corrosion by a combination of volatilization from a VCI material, vapor transport in the atmosphere of an enclosed environment, and condensation onto surfaces in the space, including absorption, dissolution, and hydrophobic effects on metal surfaces, where the rate of corrosion of metal surfaces is thereby inhibited; also called vapor-phase inhibitor, vapor-phase corrosion inhibitor, and vapor-transported corrosion inhibitor. VCI saturates metal surfaces and prevents oxygen and moisture from making contact. VCI leaves no residue, making it especially suitable for firearms protection.

Channel 122 extends into magazine body 100 along rear wall 108. It is configured to receive a strip of VCI saturated material such that corrosion inhibiting vapor is directed into the magazine well of the firearm. In embodiments, the strip of VCI saturated material is retained in channel 122 while magazine body 100 is inserted into a magazine well of a firearm.

Top end 102 includes a plurality of vents 120 between main interior cavity 114 and the environment surrounding magazine body 100. Vents 120 provide airflow between the desiccant inside main interior cavity 114 and various components inside a firearm which may be vulnerable to corrosion while stored. The desiccant absorbs water and reduces the humidity levels inside the firearm when magazine body 100 is inserted into the firearm's magazine well.

Bottom end 104 of magazine body 100 includes an access structure for loading desiccant material into main interior cavity 114. It may also be removed for optional recharging from magazine body 100 using the access structure. As shown in FIGS. 1E and 1F, the access structure is a loading door 116 that slides into slot 118 in bottom end 104. Loading door 116 is a sliding catch that is held in place using internal spring pressure. Cutouts 126 in loading door compress slightly as loading door 116 slides into slot 118 to provide the internal spring pressure. Notches 128 on either side of loading door 116 provide engage with corresponding bumps in bottom end 104, thus keeping loading door positively closed once fully inserted. When loading door 116 is secured in slot 118, it covers opening 124 which provides access to main interior cavity 114.

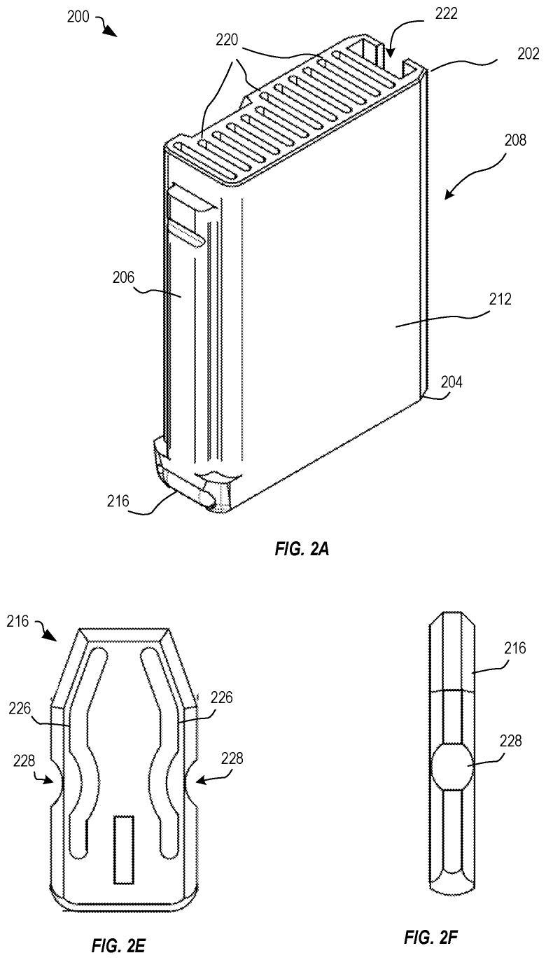

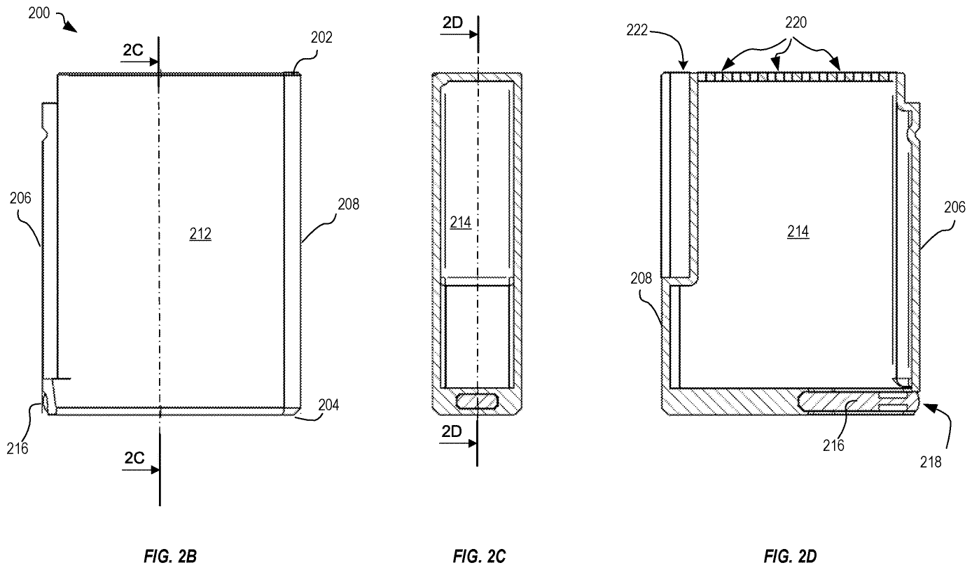

FIGS. 2A-2F show a firearm corrosion reduction device for a rifle and are best viewed together in the following description. FIG. 2A is a perspective view, FIG. 2B is a side view and FIGS. 2C-2D are sectional views of the device. FIG. 2E is a plan view of a baseplate for use with the device and FIG. 2F is a side view of the baseplate.

FIG. 2A is a perspective view of magazine body 200 for insertion into a magazine well of a firearm such as a rifle. It is sized and shaped to correspond to a factory magazine of the firearm. Magazine body 200 includes top end 202 which is inserted into the magazine well, bottom end 204, front wall 206, rear wall 208, right side wall 210, and left side wall 212. Magazine body 200 includes a main interior cavity 214 for receiving a desiccant material.

Channel 222 extends into magazine body 200 along rear wall 208. It is configured to receive a strip of VCI saturated material such that corrosion inhibiting vapor is directed into the magazine well of the firearm. In embodiments, the strip of VCI saturated material is retained in channel 222 while magazine body 200 is inserted into a magazine well of a firearm.

Top end 202 includes a plurality of vents 220 between main interior cavity 214 and the environment surrounding magazine body 200. Vents 220 provide airflow between the desiccant inside main interior cavity 214 and various components inside a firearm which may be vulnerable to corrosion while stored. The desiccant absorbs water and reduces the humidity levels inside the firearm when magazine body 200 is inserted into the firearm's magazine well.

Bottom end 204 of magazine body 200 includes an access structure for loading desiccant material into main interior cavity 214. It may also be removed for optional recharging from magazine body 200 using the access structure. As shown in FIGS. 2E and 2F, the access structure is a loading door 216 that slides into slot 218 in bottom end 204. Loading door 216 is a sliding catch that is held in place using internal spring pressure. Cutouts 126 in loading door compress slightly as loading door 116 slides into slot 118 to provide the internal spring pressure. Notches 128 on either side of loading door 116 provide engage with corresponding bumps in bottom end 104, thus keeping loading door positively closed once fully inserted. When loading door 216 is secured in slot 218, it covers opening 224 which provides access to main interior cavity 214.

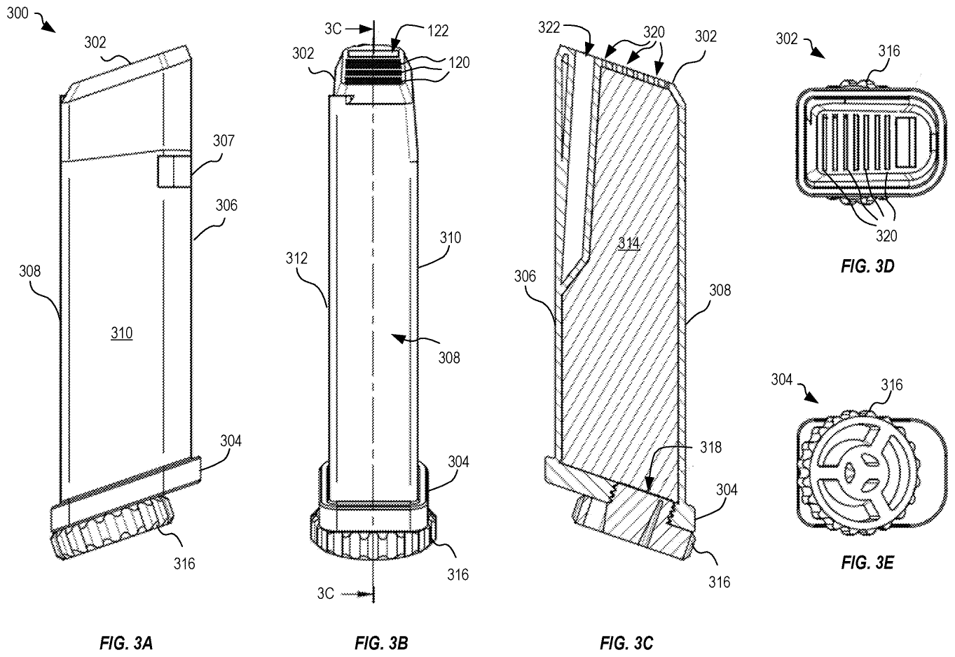

FIGS. 3A-3E show a firearm corrosion reduction device for a handgun and are best viewed together in the following description. FIG. 3A is side view, FIG. 3B is a rear view, FIG. 3C is a sectional view, FIG. 3D is a top view, and FIG. 3E is a bottom view of the device.

FIG. 3A is a side view of the device, which is magazine body 300 for insertion into a magazine well of a firearm such as a handgun. It is sized and shaped to correspond to a factory magazine of the firearm. Magazine body 300 includes top end 302 which is inserted into the magazine well, bottom end 304, front wall 306, rear wall 308, right side wall 310 and left side wall 312. Magazine body 300 includes a main interior cavity 314 for receiving a desiccant material. In embodiments, magazine body 300 includes a catch 307 for engaging with the magazine well of the firearm.

Bottom end 304 of magazine body 300 includes an access structure for loading desiccant material into main interior cavity 314. It may also be removed for optional recharging from magazine body 300 using the access structure. As shown in FIGS. 3A-3E, the access structure is a closure, such as a friction fit plug or cap, or a screw plug 316. If a screw plug 316 is employed, it will be secured in threaded opening 318 in bottom end 304 of magazine body 300. In embodiments, opening 318 and screw plug 316 may not be threaded. For example, the access structure may include a cap that is retained in opening 318 with a snap or friction fit.

Top end 302 includes a plurality of vents 320 between main interior cavity 314 and the environment surrounding magazine body 300. Vents 320 provide airflow between the desiccant inside main interior cavity 314 and various components inside a firearm which may be vulnerable to corrosion while stored. The desiccant absorbs water and reduces the humidity levels inside the firearm when magazine body 300 is inserted into the firearm's magazine well.

As shown most clearly in FIGS. 3B and 3C, a supplemental interior cavity 322 may be provided within magazine body 300. Supplemental interior cavity 322 may take a form of a channel that extends into magazine body 300 from top end 302. It is configured to receive volatile corrosion inhibitor (VCI) such that corrosion inhibiting vor is directed into the magazine well of the firearm. In embodiments, the VCI may be a strip of VCI saturated material that is sized to fit into supplemental interior cavity 322 and be retained there while magazine body 300 is inserted into a magazine well of a firearm.

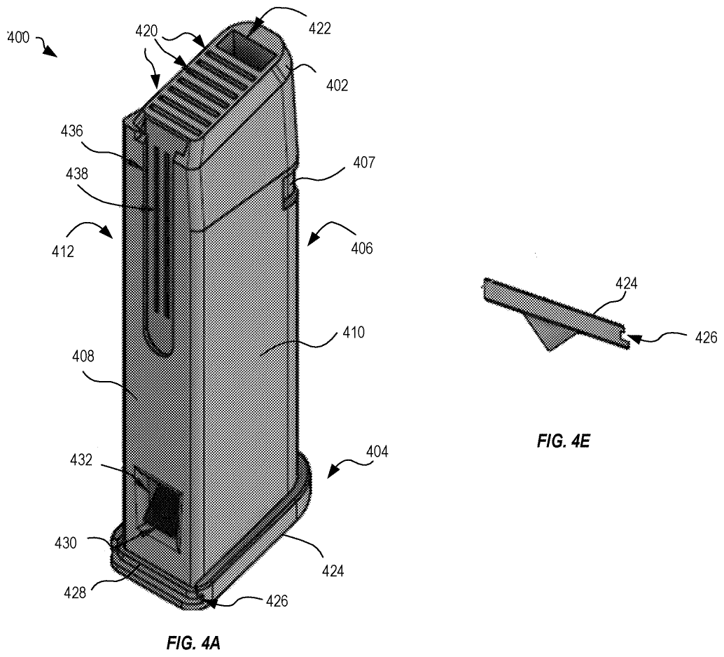

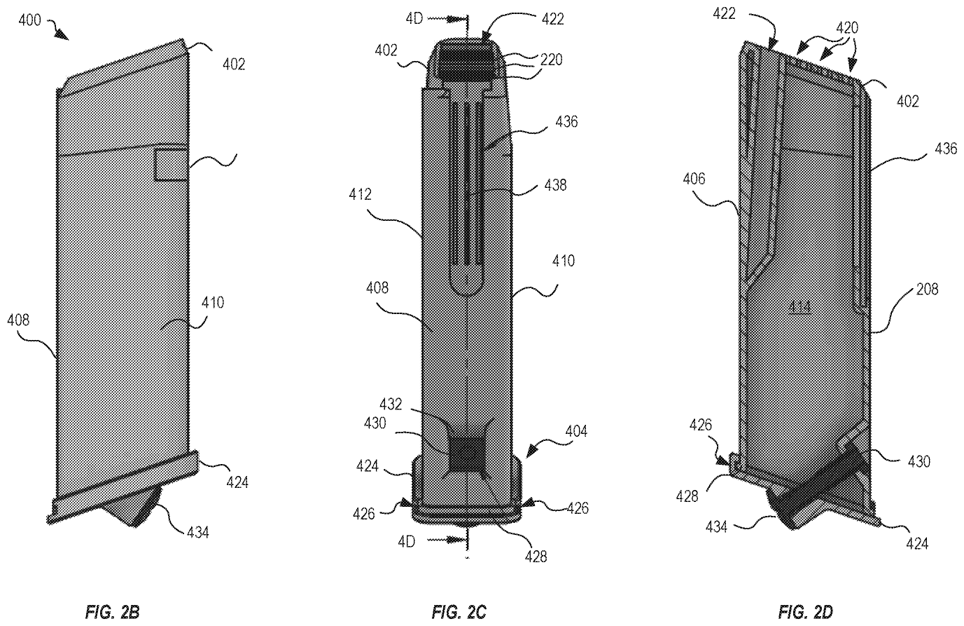

FIGS. 4A-4E show another embodiment of a firearm corrosion reduction device for a handgun and are best viewed together in the following description. FIG. 4A is a perspective view, FIG. 4B is a side view. FIG. 4C is a rear view, FIG. 4D is a sectional view, and FIG. 4E is a side view of a baseplate of the device.

FIG. 4A is a perspective view of the device, which is magazine body 400 for insertion into a magazine well of a firearm such as a handgun. It is sized and shaped to correspond to a factory magazine of the firearm. Magazine body 400 includes top end 402 which is inserted into the magazine well, bottom end 404, front wall 406, rear wall 408, right side wall 410 and left side wall 412. Magazine body 400 includes a main interior cavity 414 for receiving a desiccant material. In embodiments, magazine body 400 includes a catch 407 for engaging with the magazine well of the firearm.

Top end 402 includes a plurality of vents 420 between main interior cavity 414 and the environment surrounding magazine body 400. Vents 420 provide airflow between the desiccant inside main interior cavity 414 and various components inside a firearm which may be vulnerable to corrosion while stored. The desiccant absorbs water and reduces the humidity levels inside the firearm when magazine body 400 is inserted into the firearm's magazine well.

As shown most clearly in FIG. 4D, a supplemental interior cavity 422 may be provided within magazine body 400. Supplemental interior cavity 422 may take a form of a channel that extends into magazine body 400 from top end 402. It is configured to receive volatile corrosion inhibitor (VCI) such that corrosion inhibiting vapor is directed into the magazine well of the firearm. In embodiments, the VCI may be a strip of VCI saturated material that is sized to fit into supplemental interior cavity 422 and be retained there while magazine body 400 is inserted into a magazine well of a firearm.

Bottom end 404 of magazine body 400 includes an access structure for loading desiccant material into main interior cavity 414. It may also be removed for optional recharging from magazine body 400 using the access structure. In magazine body 400, the access structure is removeable base plate 424. Base plate 424 has a groove 426 for slidably engaging with a corresponding flange 428 on bottom end 404 of magazine body 400. Additionally, base plate 424 may be secured to magazine body 400 by inserting threaded receiver 430 through recess 432 in rear wall 408 to engage with retention screw 434 inserted through base plate 424. In embodiments, base plate 424 may also be attached to magazine body 400 using an opening such as a hinge and latch, sliding cover with catch, threaded plug, or other access structure that allows the desiccant to be selectively added or removed.

Magazine body 400 may also include humidity indicator area 436 in rear wall 408. One or more ventilation slots 238 and an optional transparent window can be provided to view either (i) a color-changing indicating desiccant located within cavity 414 or (ii) a discrete humidity indicator element mounted in the humidity indicator area 436.

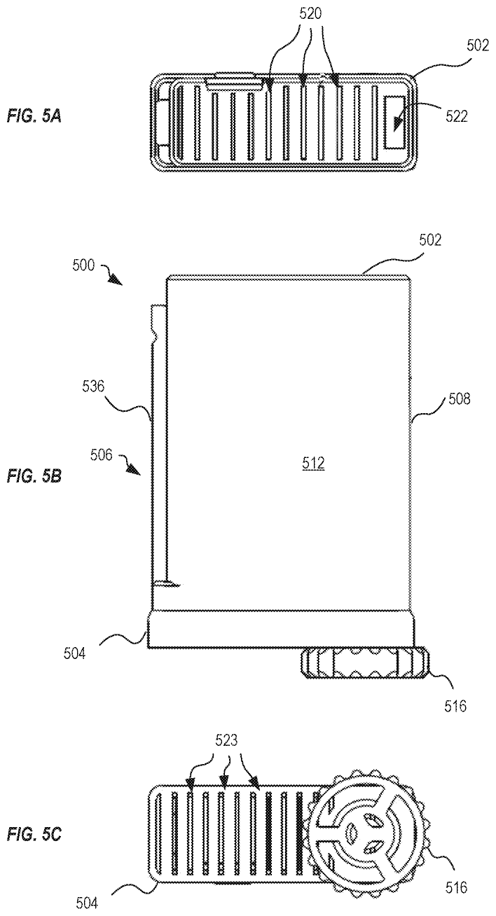

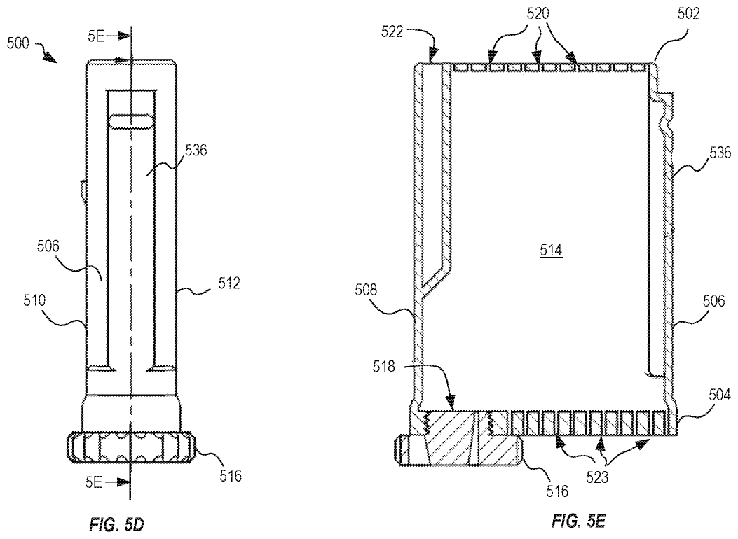

FIGS. 5A-5E show another embodiment of a firearm corrosion reduction device for a rifle and are best viewed together in the following description. FIG. 5A is a top view, FIG. 5B is a side view, FIG. 5C is a bottom view, FIG. 5D is a rear view, and FIG. 5E is a sectional view of the device.

FIG. 5B is a side view of the device, which is magazine body 500 for insertion into a magazine well of a rifle. It is sized and shaped to correspond to a factory rifle magazine. Magazine body 500 includes top end 502, bottom end 504, front wall 506, rear wall 508, right side wall 510, and left side wall 512. Magazine body 500 includes a main interior cavity 514 for receiving a desiccant material. A catch 307 can engage with the rifle magazine well.

Bottom end 504 of magazine body 500 includes an access structure for loading desiccant material into main interior cavity 514. It may also be removed for optional recharging from magazine body 500 using the access structure. As shown in FIGS. 5A-5E, the access structure is a closure. Such as a friction fit plug or cap, or a screw plug 516. If a screw plug 516 is employed, it will be secured in threaded opening 518 in bottom end 504 of magazine body 500. In embodiments, opening 518 and screw plug 516 may not be threaded.

Top end 302 includes a plurality of vents 520 between main interior cavity 514 and the environment surrounding magazine body 500. Vents 520 provide airflow between the desiccant inside main interior cavity 514 and various components inside a firearm which may be vulnerable to corrosion while stored. The desiccant absorbs water and reduces the humidity levels inside the firearm when magazine body 500 is inserted into the firearm's magazine well. As shown in FIGS. 5C and 5E, similar vents 523 may be provided in bottom end 504.

In embodiments, magazine body 500 may also include a humidity indicator area 536 in front wall 506 (or rear wall 508, depending on rifle geometry). The humidity indicator area can house a color-changing indicator or a digital humidity meter as described below.

As shown in FIG. 5E, a supplemental interior cavity 522 may be provided within magazine body 500. Supplemental interior cavity 522 may take a form of a channel that extends into magazine body 500 from top end 502. It is configured to receive volatile corrosion inhibitor (VCI) such that corrosion inhibiting vapor is directed into the magazine well of the firearm. In embodiments, the VCI may be a strip of VCI saturated material that is sized to fit into supplemental interior cavity 522 and be retained there while magazine body 500 is inserted into a magazine well of a firearm.

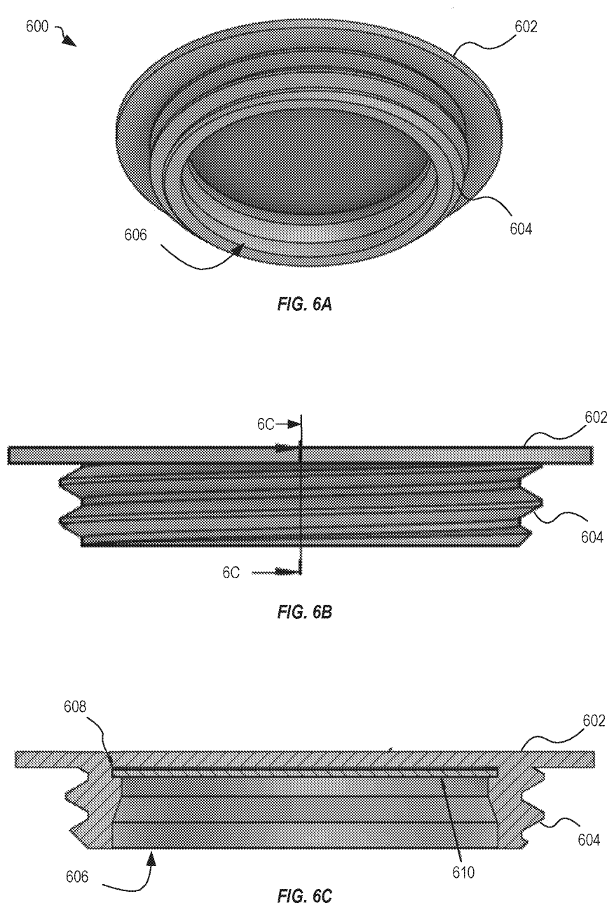

FIG. 6A is a perspective view of a screw 600 for use with a firearm corrosion reduction device, FIG. 6B is a side view and FIG. 6C is a sectional view of the screw of FIG. 6A. FIGS. 6A-6C are best viewed together in the following discussion.

Screw 600 is an example of screw plug 316 and screw plug 516. In embodiments, screw 600 is made of a transparent or clear material and includes head 602 and shank 604. Head 602 may include ridges (as shown in FIGS. 3A and 5C) or another texture or shape to assist with removal from a magazine body, either by hand or with a tool. Shank 604 may be threaded as shown or may use some other mechanical lockup to retain screw 600 in a magazine body. Shank 604 includes a cavity 606.

Cavity 606 has a wider diameter to form pocket 608 just below head 602. Pocket 608 retains humidity indicator 610, which is exposed to desiccant inside the magazine body and will indicate desiccant humidity level. It is visible through transparent head 602.

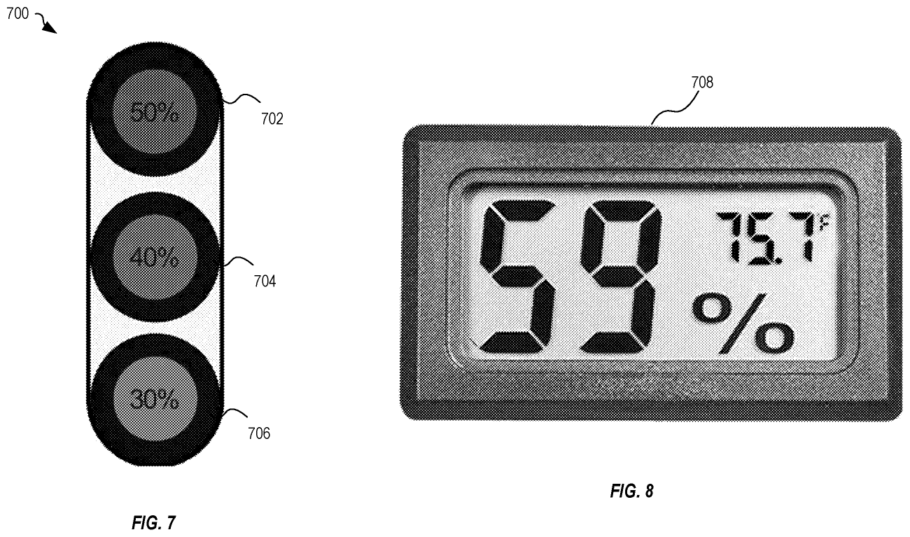

FIG. 7 is a diagram of a humidity indicator 700 that may be used in any of the embodiments disclosed herein. Indicator 700 has a range from 30% to 50% as shown by indicator dots 702, 704, and 706. All 3 indicator dots may be used, for example, in humidity indicator area 436 of FIG. 4C, or a single indicator dot could be selected for use in screw 600.

FIG. 8 is a diagram of a digital humidity meter 708. This type of indicating device may show humidity and/or temperature. The display shown in FIG. 8 is for purposes of illustration and other information may be displayed or the format of the information may be changed.

Further, humidity levels may be shown with an indicating desiccant (e.g. desiccant that changes color with amount of absorbed water). In this case, any of the indicating areas on magazine bodies disclosed herein may be provided with a window for visibility into the interior cavity.

Embodiments disclosed herein show perforations at various locations in a magazine body to allow desiccant within the body to perform a drying effect. Locations for perforations are not limited to those shown in the figures. In addition, some or all of the magazine body may be made of a permeable material. Perforations may be implemented one of the following ways:

Perforations in at least one area of the magazine body, such as facing toward the firearm chamber, firing pin, and breach face or bolt.

Perforations throughout the magazine body.

Perforations only in specified areas of the magazine body.

Magazine body partially or fully made of permeable material.

Magazine body incorporates permeable material as a portion of design.

Any of the magazine bodies disclosed herein may be manufactured as a single piece or multiple pieces that are assembled using glue or welds, for example. They may be manufactured using additive manufacturing processes or injection molding, or other techniques. They may be made with a variety of materials including polymers as long as the material does not exhibit galvanic/corrosion issues and withstands oils/solvents (e.g., polymer body with chemical resistance; stainless or polymer screws). High visibility coloration may be incorporated to prevent confusion with ammunition magazines.

Firearms experts often recommend a 30-50% relative humidity level for best preservation of firearms. The amount of desiccant needed to achieve this humidity level range may be calculated using the following equation published by the Canadian Conservation Institute:

$$Q = \frac{{C}_{eq} \cdot D \cdot V \cdot N \cdot t}{{M}_{H} \cdot F}$$

Where
   Q is recommended quantity of dry sorbents (kg)
   C_{eq} is concentration of water vapour at equilibrium (g/m³)
   D is decimal difference between the RH outside the enclosure and the targeted RH inside (no unit)
   V is net volume of air in the enclosure (m³)
   N is air exchange rate (1/day)
   t is minimum number of days the targeted RH range must be maintained (days)
   M_{H} is specific moisture reservoir of sorbent, including the effect of hysteresis (g/kg for a 1% RH change)
   F is targeted range of RH fluctuation (%)

Note that environmental relative humidity, temperature, and number of air exchanges per day are variables solely within the control of the ultimate end user. Several examples are provided to illustrate the use of the equation.

### Assumptions for all Examples

The average outdoor humidity in Houston, Texas is 78%. Average comfortable indoor humidity levels typically run between 30% to 50%, but will be assumed at 55%. Indoor temperatures, when used, are assumed to be 70 degrees Fahrenheit.

Large pistols have external dimensions that are approximately 43 cubic inches, or 0.0007046438 m³. Assuming the need to condition double that amount of space, this is 86 cubic inches, or 0.0014092875 m³.

Calculations show that a pistol version of the magazine bodies disclosed herein contains 1.4 ounces of silica gel desiccant.

Calculations show that a typical AR-15 rifle version of the magazine bodies disclosed herein contains 2.5 ounces of silica gel desiccant.

Air exchanges in safes for firearms is 0.5 per day due to intrusion prevention and fire resistance features.

Air exchanges in airtight cases for firearms is 0.1 per day due to infrequent openings.

### Example #1: Pistols in a Gun Safe

Two pistols placed in a gun safe, each one with a device as disclosed herein inserted. The pistols are stored within a home.

Environmental Condition: Interior volume 330 cubic inches, 0.5 air exchanges per day, and in a conditioned home with temperature average 70 degrees Fahrenheit, and 55% humidity.

Required Desiccant: 1.5 oz of silica gel desiccant needed to maintain humidity in the range of 30%-50% for a year.

Result: Two devices present with 1.4 oz silica gel desiccant each significantly exceeds the required amount.

### Example #2: Rifles in Rifle Safe

Five AR-15 type rifles are stored in a gun safe, each one with a device as disclosed herein inserted. The rifles are stored within a home.

Environmental Condition: Interior volume 7,362 cubic inches, 0.5 air exchanges per day, and in a conditioned home with temperature average 70 degrees Fahrenheit, and 55% humidity.

Required Desiccant: 33.5 oz of silica gel desiccant needed to maintain humidity in range of 30%-50% for a year.

Result: Five devices with 2.5 oz of silica gel equals 10 oz, or about 30% of the required amount to condition the whole space for a year. However, this does not take into account the localizing effect of the magazine. If the interior of the rifles experience 10% of the overall air exchange, then the silica gel present is more than sufficient to condition the air within the rifles.

### Example #3: Single Rifle in Airtight Case

One AR-15 type rifle in an airtight rifle case, stored in patrol car. Rifle has a device as disclosed herein inserted.

Environmental Condition: 3,000 cubic inch interior volume, 0.1 air exchanges per day, temperature 45-90 degrees Fahrenheit, and humidity fluctuating between 50%-80% (average 65%).

Required Desiccant: 4 oz of silica gel desiccant needed to maintain humidity in the range of 30%-50% for a year.

Result: One device with 2.5 oz of silica gel is less than half the required amount to condition the whole space for a year. However, this does not take into account the localizing effect of the magazine. If the interior of the rifles experience 10% of the overall air exchange, then the silica gel present is more than sufficient to condition the air within the rifles.

### Example #4: Single Pistol in a Vehicle Safe

One large size pistol in an airtight pistol safe, which is properly installed in a vehicle. Pistol has a device as disclosed herein inserted.

Environmental Condition: 420 cubic inch interior volume, 0.1 air exchanges per day, temperature 45-90 degrees Fahrenheit, and humidity fluctuating between 50%-80% (average 65%).

Required Desiccant: 0.3 oz of silica gel desiccant needed to maintain humidity between 30%-50% for a year.

Result: One device with 1.4 oz of silica gel far exceeds requirement.

### Optional VCI

Reducing humidity with a desiccating agent is one way to reduce corrosion, but not the only way.

Any of the embodiments disclosed herein may also incorporated VCI while taking little additional space. One such product specifies that a square inch of VCI material protects up to ½ cubic foot for 2 years or more. The present disclosure contemplates using 1 square inch in pistol applications. This provides 864 cubic inches of protection, and as a result provides protection in Examples #1 and #4.

Embodiments disclosed herein provide the technical benefit of reducing rust or corrosion of metals in firearms. The disclosed firearm corrosion reduction devices provide the following benefits:

Drying functionality is positioned within the firearm to be protected, close to critical steel parts of firearm, namely the breach face or bolt, chamber, and firing mechanism.

The device to provide drying functionality is easily inserted into and removed from the firearm.

The firearm may be conveniently stored and moved with the device in place.

Desiccant may be removed from the device and replaced with recharged desiccant.

Optional volatile corrosion inhibitor (VCI) is included for enhanced corrosion protection.

Although specific features of various embodiments of the disclosure may be shown in some drawings and not in others, such illustrative techniques are for convenience only. In accordance with the principles of the disclosure, a particular feature shown in a drawing may be referenced and/or claimed in combination with features of the other drawings.

Changes may be made in the above methods and systems without departing from the scope hereof. For example, any of the magazine bodies disclosed herein may be made without an access port and pre-loaded with desiccant for a single-use application. Any of the magazine bodies discussed herein may be used with a pistol magazine, a rifle magazine, a detachable box magazine, a carbine magazine, or any other firearm magazine.

Further, VCI saturated material may be internal or external to the magazine body, or it may form part of the magazine body itself.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A corrosion reduction device for a firearm, comprising:
a magazine body for insertion into a magazine well of the firearm, the magazine body having a main interior cavity configured to receive a desiccant material;
an access structure on the magazine body to load the desiccant material into the main interior cavity; and
at least one vent in the magazine body between the main interior cavity and the firearm interior to provide communication of desiccant material from the main interior cavity to the firearm interior.

2. The device of claim 1, the magazine further comprising:
a top end; and
a bottom end;
wherein the access structure is on the bottom end of the magazine body and includes an opening for loading or removing the desiccant material from the interior cavity.

3. The device of claim 2, wherein the access structure is a loading door that slides into a slot.

4. The device of claim 2, wherein the opening is threaded for receiving a threaded screw.

5. The device of claim 4, wherein the threaded screw comprises an indicator representing a saturation state of the desiccant in the interior cavity.

6. The device of claim 2, wherein the access structure comprises a base plate secured to the magazine body with a screw.

7. The device of claim 2, wherein the access structure comprises a baseplate attached to the magazine body with a hinge.

8. The device of claim 2, wherein the access structure comprises a cap that snaps into the opening.

9. The device of claim 1, wherein the magazine body is sized and shaped to correspond to a factory magazine corresponding to the firearm and configured to be inserted into a magazine well of the firearm.

10. The device of claim 1, wherein a plurality of vents are located on a top end of the magazine body.

11. The device of claim 1, further comprising an indicator representing a saturation state of the desiccant in the interior cavity.

12. The device of claim 1, further comprising a digital humidity meter attached to the magazine body.

13. The device of claim 1, wherein the magazine body is partially or fully made of a permeable material.

14. The device of claim 1, the magazine body further comprises a supplemental interior cavity configured to receive a volatile corrosion inhibitor (VCI) such that corrosion-inhibiting vapor is directed into the magazine well of the firearm.

15. The device of claim 14, wherein the VCI comprises a strip of VCI-saturated material.

16. The device of claim 1, wherein the magazine body is selected from a pistol magazine, rifle magazine, detachable box magazine, or carbine magazine.

17. The device of claim 1, wherein the desiccant material comprises silica gel.

18. The device of claim 1, wherein the desiccant material is replaceable and rechargeable.

19. A method of inhibiting corrosion in a firearm, comprising:
loading a desiccant into a non-functional magazine-shaped device;
inserting the device into a magazine well of the firearm such that vents on the device face a chamber region;
storing the firearm; and
removing and recharging the desiccant when an indicator reaches a predetermined state.

20. A corrosion inhibition kit, comprising:
the device of claim 1;
one or more sealed desiccant refill packets sized to fill the main interior cavity; and
an optional volatile corrosion inhibitor strip sized to fit within a supplemental interior cavity of the device.
